(19) United States
(12) Patent Application Publication
(10) Pub. No.: US 2026/0099968 A1
(43) Pub. Date: Apr. 9, 2026

(54) SYSTEM AND METHODS FOR GENERATING COMPOSITE IMAGES

(71) Applicant: Shopify Inc., Ottawa (CA)

(72) Inventor: Stephan LEROUX, East Gwillimbury (CA)

(73) Assignee: Shopify Inc., Ottawa (CA)

(21) Appl. No.: 18/909,025

(22) Filed: Oct. 8, 2024

(51) Int. Cl. G06T 11/60; G06F 40/40; G06T 7/194; G06V 10/26; G06V 10/764

(52) U.S. Cl. CPC G06T 11/60; G06F 40/40; G06T 7/194; G06V 10/26; G06V 10/764; G06T 2200/24; G06T 2207/20212

(57) ABSTRACT

A computer-implemented is disclosed. The method includes: obtaining a composite image depicting an identifiable foreground object; performing image segmentation to isolate a foreground object from the composite image, the image segmentation yielding a segmented composite image; determining object attributes of the foreground object based on image analysis of the segmented composite image; obtaining at least one prompt for a text-to-image model based on the object attributes of the foreground object, the at least one prompt defining an intended replacement background for the composite image; providing, to the text-to-image model, instructions to generate a replacement background image for the composite image based on the at least one prompt; receiving, from the text-to-image model, a replacement background image for the composite image; and generating a new composite image, the generating including compositing portions of the composite image corresponding to the foreground object with the replacement background image.

### TECHNICAL FIELD

The present disclosure relates to generative artificial intelligence (AI) systems and, more particularly, to techniques that leverage use of machine learning models for composite image generation.

### BACKGROUND

A composite image generally consists of foreground objects inserted into a background image. Text-to-image models, such as Stability AI's Stable Diffusion™ and OpenAI's DALL-E™ 2, may be employed to generate or modify composite images. For example, a replacement background image for a given composite image may be generated using a text-to-image model. A new composite image may then be formed by combining the foreground objects of the original image with the replacement background image.

A text-to-image model requires well-crafted text prompts to generate high-quality and contextually appropriate images. In particular, the quality of the generated images is directly dependent on the quality of the input text prompt(s). Users often lack expertise in prompt engineering, resulting in generation of sub-optimal images. Existing model-based solutions for composite image generation fail to provide suitable guidance to users for prompt creation. As a consequence, users may engage in a protracted trial-and-error process and be led to expend significant resources (e.g., computing resources, tokens, etc.) in order to arrive at their desired composite image.

### BRIEF DESCRIPTION OF THE DRAWINGS

Reference will now be made, by way of example only, to the accompanying drawings which show example embodiments of the present application, and in which:

FIG. 1 illustrates, in block diagram form, an example system for implementing image generation that integrates use of a generative AI model;

FIG. 2 shows, in flowchart form, an example method for generating a new composite image based on a reference image;

FIG. 3 shows, in flowchart form, an example method for generating a replacement background image for a reference image;

FIG. 4 shows, in flowchart form, an example method of obtaining predictive text data for an input prompt to a text-to-image model;

FIG. 5 shows, in flowchart form, another example method for generating a new composite image based on a reference image;

FIG. 6 is a block diagram of an example computing system, which may be used to implement examples of the present disclosure;

FIG. 7 is a block diagram of a simplified convolutional neural network, which may be used in examples of the present disclosure; and

FIG. 8 is a block diagram of a simplified transformer neural network, which may be used in examples of the present disclosure.

Like reference numerals are used in the drawings to denote like elements and features.

### DETAILED DESCRIPTION OF IMPLEMENTATIONS

In an aspect, the present application discloses a computer-implemented method. The method may include: obtaining a composite image depicting an identifiable foreground object; performing image segmentation to isolate a foreground object from the composite image, the image segmentation yielding a segmented composite image; determining object attributes of the foreground object based on image analysis of the segmented composite image; obtaining at least one prompt for a text-to-image model based on the object attributes of the foreground object, the at least one prompt defining an intended replacement background for the composite image; providing, to the text-to-image model, instructions to generate a replacement background image for the composite image based on the at least one prompt; receiving, from the text-to-image model, a replacement background image for the composite image; and generating a new composite image, the generating including compositing portions of the composite image corresponding to the foreground object with the replacement background image.

In some implementations, obtaining the at least one prompt for the text-to-image model may include: determining current text input in an input field of a graphical user interface; providing, to a large language model (LLM), instructions to generate predictive text data based on the object attributes of the foreground object and the current text input in the input field; and presenting the predictive text data via the graphical user interface.

In some implementations, the predictive text data may comprise a next word suggestion.

In some implementations, the method may further include: receiving, via the graphical user interface, user selection of first text from the predictive text data; and combining the current text input in the input field with the selected first text to obtain the at least one prompt.

In some implementations, the predictive text data may include a plurality of word suggestions and each of the plurality of word suggestions may be presented as a selectable option via the graphical user interface.

In some implementations, determining the object attributes of the foreground object may include providing at least a portion of the segmented composite image to a language model that is trained to output attribute labels of input images.

In some implementations, the language model may be fine-tuned using a dataset of images depicting first objects and attribute labels associated with the first objects.

In some implementations, the method may further include: computing input embeddings using the object attributes of the foreground object and the current text input; and determining a ranking of outputs of the LLM based on a similarity measure between embeddings of predictive text candidates and the input embeddings.

In some implementations, the method may further include extracting the foreground object from the segmented composite image, and the new composite image may be generated based on combining the extracted foreground object with the replacement background image.

In some implementations, obtaining the at least one prompt for the text-to-image model may include providing, to an LLM, instructions to generate one or more candidate prompts based on the object attributes of the foreground object, and providing instructions to the text-to-image model to generate the replacement background image may include: receiving, from the LLM, the generated candidate prompts; and for each generated candidate prompt, providing, to the text-to-image model, instructions to generate a candidate background image corresponding to the candidate prompt.

In some implementations, the method may further include presenting, via a graphical user interface, the candidate background images corresponding to the one or more candidate prompts as selectable options, and the replacement background image may comprise a selection of one of the candidate background images.

In some implementations, the method may further include: receiving, via the graphical user interface, a selection of one of the candidate background images and user input of modifications to the candidate prompt associated with the selected candidate background image; and providing, to the text-to-image model, instructions to generate a modified candidate background image based on the modified candidate prompt.

In some implementations, performing the image segmentation may include identifying a class of the foreground object using a classifier.

In another aspect, the present application discloses a computing system. The computing system includes a processor and a memory coupled to the processor. The memory stores computer-executable instructions that, when executed by the processor, may configure the processor to: obtain a composite image depicting an identifiable foreground object; perform image segmentation to isolate a foreground object from the composite image, the image segmentation yielding a segmented composite image; determine object attributes of the foreground object based on image analysis of the segmented composite image; obtain at least one prompt for a text-to-image model based on the object attributes of the foreground object, the at least one prompt defining an intended replacement background for the composite image; provide, to the text-to-image model, instructions to generate a replacement background image for the composite image based on the at least one prompt; receive, from the text-to-image model, a replacement background image for the composite image; and generate a new composite image, the generating including compositing portions of the composite image corresponding to the foreground object with the replacement background image.

In another aspect, the present application discloses a non-transitory, processor-readable medium storing processor-executable instructions that, when executed by a processor, may configure the processor to: obtain a composite image depicting an identifiable foreground object; perform image segmentation to isolate a foreground object from the composite image, the image segmentation yielding a segmented composite image; determine object attributes of the foreground object based on image analysis of the segmented composite image; obtain at least one prompt for a text-to-image model based on the object attributes of the foreground object, the at least one prompt defining an intended replacement background for the composite image; provide, to the text-to-image model, instructions to generate a replacement background image for the composite image based on the at least one prompt; receive, from the text-to-image model, a replacement background image for the composite image; and generate a new composite image, the generating including compositing portions of the composite image corresponding to the foreground object with the replacement background image.

Other example implementations of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “generative AI model” (or simply “generative model”) may be used to describe a machine learning model. A generative AI model may sometimes be referred to, or may use, a language learning model. A trained generative AI model may respond to an input prompt by generating and producing an output or result. The output/result may be generated by the generative AI model through interpreting the intent and context of the prompt. In some cases, the generative AI model may be implemented with constraints on the acceptable prompts. In some cases, this may include a prompt template. A prompt template may specify that prompts have a certain structure or constrained intents, or that acceptable prompts exclude certain classes of subject matter or intent, such as the production of results or outputs that are violent, pornographic, etc.

Significant advances have been made in recent years in generative AI models. Different implementations may be trained to create digital art, computer code, conversation text responses, or other types of outputs. Examples of generative AI models include Stable Diffusion™ by Stability AI Ltd., ChatGPT by OpenAI, DALL-E™ 2 by OpenAI, and GitHub CoPilot™ by GitHub and OpenAI.

The models are typically trained using a large set of training data. For instance, in the case of AI for generating images, the training data set may include a database of millions of images tagged with information regarding the contents, style, artist, context, or other data about the image or its manner of creation. The generative AI trained on such a data set is then able to take an input prompt in text form, which may include suggested topics, features, styles or other suggestions, and provide an output image that reflects, at least to some degree, the input prompt.

### Model-Based Generation of Composite Images

Text-to-image models are a type of generative AI model that generates images from natural language descriptions. Text prompts can be used to generate new images or edit existing images. In particular, variations or edited versions of existing images may be created using a text-to-image model. For example, an image may be provided as input to a text-to-image model along with a text prompt that captures a user's specific intents for modifying the image. In the context of a composite image, the foreground object(s) and/or background of the image may be edited, replaced, or deleted through suitable prompt engineering.

Existing tools for facilitating prompt engineering typically include basic functionalities designed to align user-inputted prompts with a generative model's interpretative capabilities. Users may be presented with recommendations for formatting text prompts, examples of suitable language, and other generic instructions relating to prompt creation. While these tools may be suitable for certain limited uses and applications, they do not broadly support effective expression of user intents through prompts or resource efficiency vis-à-vis customized generation of new data instances.

Generating a composite image may involve combining portions from multiple image sources. A text-to-image model that is tasked with compositing an image may thus process image data of a plurality of different images. Certain models, such as OpenAI's GPT-4, impose costs for use of the model—for example, the cost may be expressed as a price per a fixed quantity of “tokens” (i.e., the smallest units of text that the model can process). As such, efficiency becomes a crucial factor during prompt engineering. Prompting a text-to-image model on a “trial-and-error” basis—as contrasted with a context-aware and systematically guided approach—may lead to high usage costs and significant consumption of computing resources for a composite image generation process. It is thus desired to provide a tool that enables effective prompt creation for an image generation model while also promoting overall resource (e.g., processing units, tokens, etc.) efficiency.

The present application discloses a text-to-image model-based solution for generating composite images. The solution includes at least three main components:
1. Image segmentation. For a given composite image, the proposed system performs image segmentation to isolate one or more foreground objects from the composite image. The segmentation algorithm may involve training an object detection model to recognize items belonging to a set of known items, e.g., products of a product catalogue. Additionally, or alternatively, the segmentation algorithm may employ a classifier for identifying a class of items, and then select a segmentation mask corresponding to the identified class. In some implementations, the system may obtain metadata associated with the composite image and use information contained in the metadata to identify the foreground object(s).
2. Attribute extraction. An attribute extraction module is configured to take an image of the foreground object as input and output attribute labels for the object. The attribute extraction module may employ a multi-modal language model. The model may be fine-tuned on attribute labels that are specific to a particular application or platform, such as an e-commerce platform. Alternatively, the attribute extraction module may employ a multi-class machine learning classifier that is trained to extract attributes from the image. Attributes may include, among others, object material, color, lighting parameters, size, style, and the like.
3. Guidance for text prompt creation. The system provides a user interface that facilitates effective prompt creation for generating composite images. The user interface includes at least one designated input field for receiving text input from a user. The text input, or augmentation thereof, may be formed into an image generation prompt that is provided to a text-to-image model. The image generation prompt comprises a natural language description of an image that is desired to be generated. For example, an image generation prompt may comprise instructions for generating a new background image for a given foreground object from a reference composite image. The user interface is designed to present, in real-time, predictive text data (e.g., next word suggestion) for guiding user construction of image generation prompts.

As the user enters text, in an input field, for inclusion in an image generation prompt, the system is configured to provide suggestions for completing the text prompt. In at least some implementations, the system employs a large language model to generate the suggestions in real-time, given the inputs of: a class of the foreground object; attributes of the foreground object; and the user's current text input. In particular, the system may implement an LLM-powered next word (and/or sentence) prediction algorithm to suggest text for inputting in the input field. The algorithm may enable the system to suggest suitable text for the image generation prompt in a manner that accounts for context of both the foreground object(s) and the user.

In some implementations, the system may additionally compute vector embeddings using the inputs (e.g., class of the foreground object, object attributes, and user's current text input). The system may re-rank the suggestions or predictive text items for the next word in the sequence based on a similarity measure between the embeddings of the candidate words and the embeddings of the inputs.

As an alternative to generating next word/sentence suggestions based on the current text input, the system may provide the foreground object analysis data (i.e., object class and attributes) to a large language model to generate candidate prompts. For each candidate prompt, the system may provide instructions to a text-to-image model to generate an image based on said prompt. The “candidate images” that are generated in this manner can then be presented to the user as possible candidates for the replacement background image of the composite image.

In some implementations, a user may be provided with options for modifying a candidate background image, by revising the underlying input prompt associated with the candidate background image. If the user revises the prompt, the system generates instructions for the text-to-image model to generate an updated background image based on the revised prompt. The instructions may include the previous candidate image as an input alongside the revised prompt. In this way, the system may maintain control over certain aspects of the previous candidate image (e.g., style, lighting, etc.) while replacing other aspects based on the user-revised prompt.

The proposed system represents an improvement in user interface technology, specifically in relation to software tools for interfacing with text-to-image models. The system enables effective real-time control of user interface elements corresponding to selectable options (e.g., a ranking of predictive text items) for generating composite images. The improvement may also be realized in the form of increased efficiency in model-based image generation; more particularly, the proposed user interface supports real-time customization of composite images and modification of text prompts corresponding to candidate images when using a text-to-image model. The proposed user interface is an improvement over interfaces designed for receiving user input of text prompts that (1) do not provide any predictive text data, (2) provide only static predictive text data (i.e., not responsive to real-time user input), or (3) provide predictive text data without regard to context, such as priority, relevance, and/or importance, of the text items.

To better illustrate additional details regarding the methods and systems of the present application, some concepts relevant to generative AI models, neural networks, and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object class, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train an ML model that is intended to classify images, the training dataset may be a collection of images. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

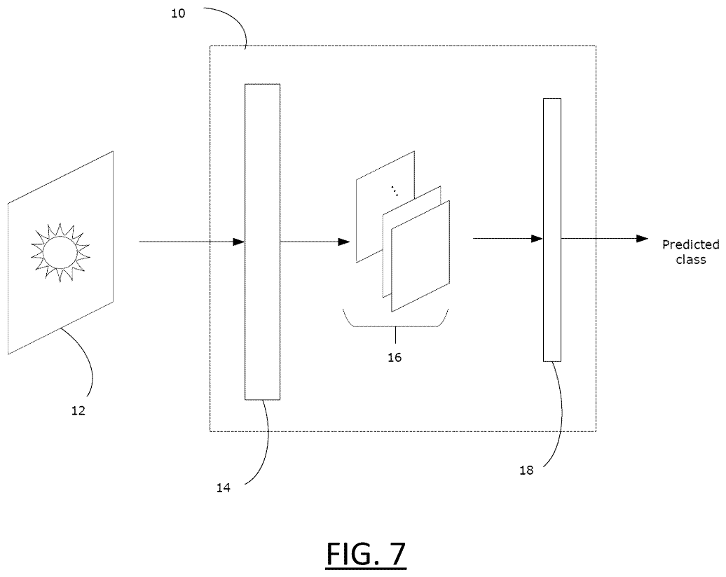

FIG. 7 is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted class or label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted class for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to an ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

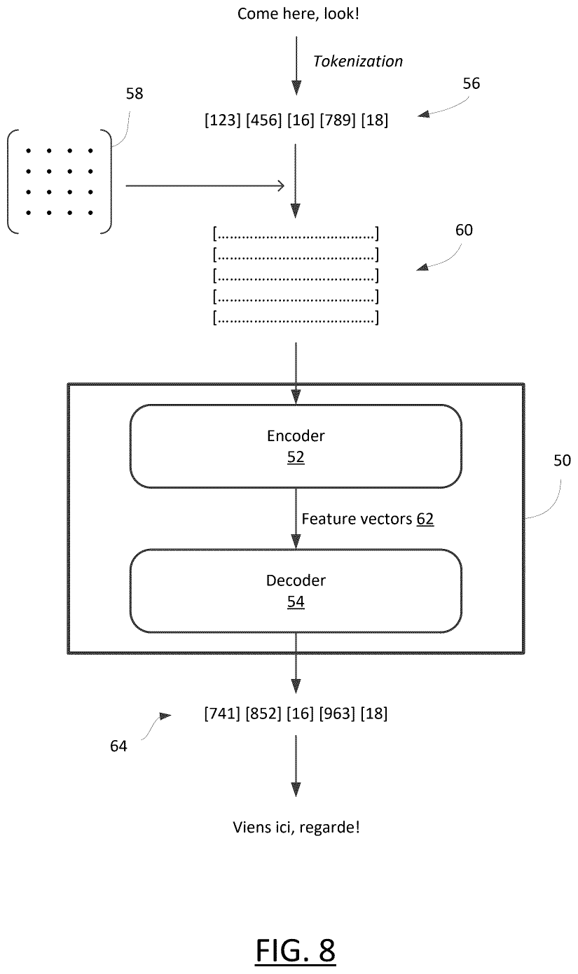

FIG. 8 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a class of the textual sequence (e.g., may classify the textual sequence as a poem, a list, a paragraph, etc.), a [EOT] token may be another special token that indicates the end of the textual sequence, other tokens may provide formatting information, etc.

In FIG. 8, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 9 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally, or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally, or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

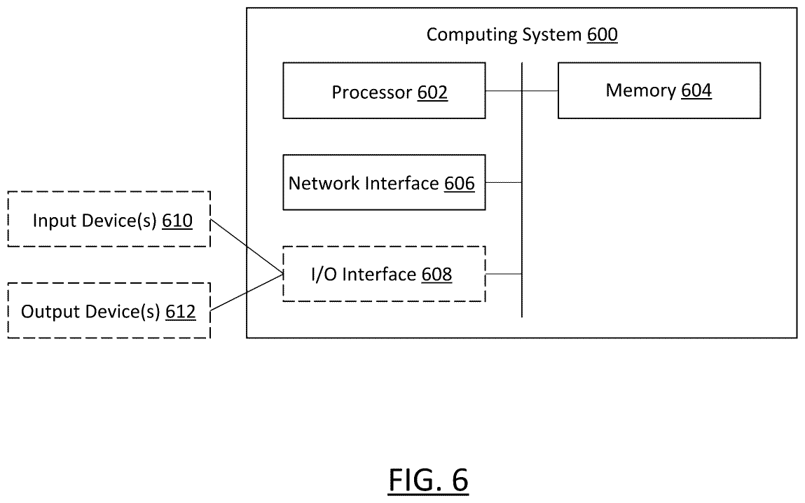

FIG. 6 illustrates an example computing system 600, which may be used to implement examples of the present disclosure, such as a prompt generation engine to generate prompts to be provided as input to a language model such as an LLM. Additionally, or alternatively, one or more instances of the example computing system 600 may be employed to execute the LLM. For example, a plurality of instances of the example computing system 600 may cooperate to provide output using an LLM in manners as discussed above.

The example computing system 600 includes at least one processing unit, such as a processor 602, and at least one physical memory 604. The processor 602 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 604 may include a volatile or non-volatile memory (e.g., a flash memory, a random-access memory (RAM), and/or a read-only memory (ROM)). The memory 604 may store instructions for execution by the processor 602, to the computing system 600 to carry out examples of the methods, functionalities, systems and modules disclosed herein.

The computing system 600 may also include at least one network interface 606 for wired and/or wireless communications with an external system and/or network (e.g., an intranet, the Internet, a P2P network, a WAN and/or a LAN). A network interface may enable the computing system 600 to carry out communications (e.g., wireless communications) with systems external to the computing system 600, such as a language model residing on a remote system.

The computing system 600 may optionally include at least one input/output (I/O) interface 608, which may interface with optional input device(s) 610 and/or optional output device(s) 612. Input device(s) 610 may include, for example, buttons, a microphone, a touchscreen, a keyboard, etc. Output device(s) 612 may include, for example, a display, a speaker, etc. In this example, optional input device(s) 610 and optional output device(s) 612 are shown external to the computing system 600. In other examples, one or more of the input device(s) 610 and/or output device(s) 612 may be an internal component of the computing system 600.

A computing system, such as the computing system 600 of FIG. 6, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

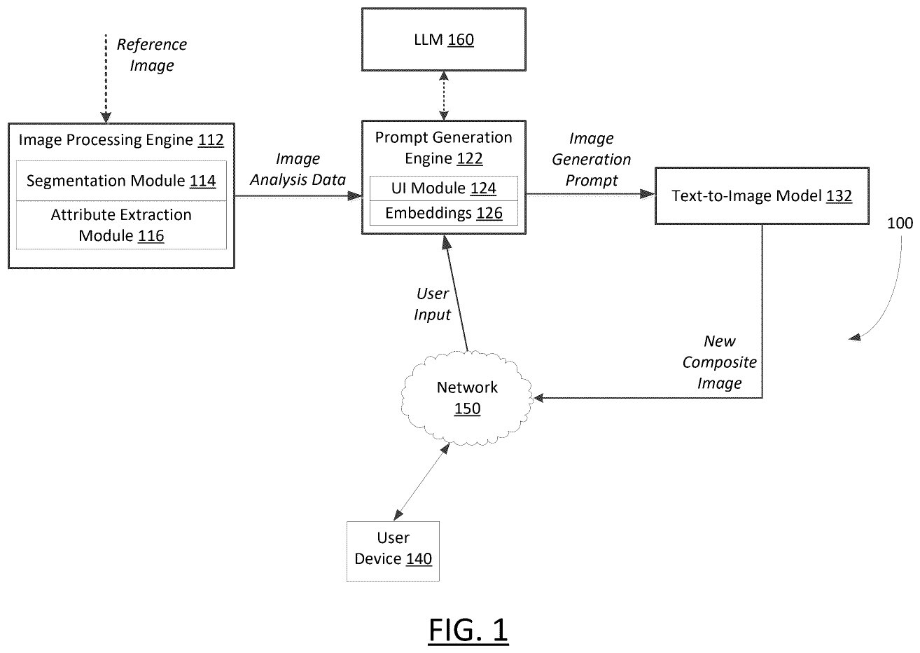

Reference is made to FIG. 1, which illustrates, in block diagram form, an example system 100. The system 100 may be implemented using one or more computing devices.

The system 100 includes an image processing engine 112, a prompt generation engine 122, and a text-to-image model 132. The text-to-image model 132 is an unsupervised or semi-supervised machine learning algorithm that has been trained using a set of training data content. The text-to-image model 132 may be a transformer 50 (FIG. 8), as described above. The text-to-image model 132 is configured to take an input prompt, and produces an output related to the input prompt. In some implementations, the text-to-image model 132 may be a generative adversarial network. In some implementations, the text-to-image model 132 may be a transformer-based model.

The user input may comprise user-supplied text input that is received from a user device 140 via a network 150. In the context of image generation, the user input may be or include instructions for modifying a reference image (also provided by the user). In at least some implementations, the user input is processed by the system 100 to generate a suitable prompt for inputting to the text-to-image model 132. In particular, the user input may be modified (e.g., augmented) to produce an image generation prompt that is suitable for a particular text-to-image model 132.

The image processing engine 112 is configured to receive user-supplied reference images and perform image analysis on the reference images. By way of example, when a reference image is a composite image, the image analysis data may include object class and attribute data for one or more identified foreground objects in the reference image. The image analysis data output by the image processing engine 112 may be fed into the prompt generation engine 122, which subsequently uses the image analysis data for constructing an image generation prompt. In particular, the image analysis data may be combined with user input, i.e., input text, to automatically construct an image generation prompt and/or provide the user with predictive text data to facilitate manual construction of the image generation prompt.

The UI module 124 provides a user interface associated with the prompt generation engine 122. In particular, the UI module 124 is configured to generate, edit, and otherwise control a graphical user interface for use in interfacing with the text-to-image model 132. By way of example, the UI module 124 may provide a graphical user interface that enables users to initiate image generation and/or editing processes leveraging use of a generative AI model (e.g., a text-to-image model 132).

An embeddings module 126 creates vector representations of data. Embeddings are computed using machine learning models. The embeddings module 126 is configured to implement one or more embedding models for processing different types of data. Examples of pre-trained embedding models which may be implemented include: Word2Vec, Doc2Vec, Universal Sentence Encoder, Global Vectors (GloVe), Embeddings from Language Models (ELMo), FastText, MobileNet v2, SentenceBERT, InferSent, etc.

The prompt generation engine 122 is configured to compute similarity between vectors in an embedding space. In particular, the prompt generation engine 122 (and more specifically, the embeddings module 126) may use one or more metrics for calculating vector similarity such as, but not limited to, L2 (Euclidean) distance, cosine similarity, and inner product (dot product).

The system 100 may be configured to send the output over the network 150 to the user device 140. In particular, search results for a user-inputted query that are output by the prompt generation engine 122 may be transmitted to the user device 140 via the network 150. For example, the search results may be provided to the user device 140 for displaying on a user interface thereon in connection with a user-initiated search.

The network 150 is a computer network. In some implementations, the network 150 may be an internetwork such as may be formed of one or more interconnected computer networks. For example, the network 150 may be or may include an Ethernet network, an asynchronous transfer mode (ATM) network, a wireless network, or the like.

In some example implementations, the prompt generation engine 122 may be integrated as a component of an e-commerce platform. That is, an e-commerce platform may be configured to implement example embodiments of the prompt generation engine 122. In particular, the subject matter of the present application, including example methods for model-based generation of composite images, may be employed in the specific context of e-commerce. For example, the prompt generation engine 122 may be adapted to facilitate automated generation of images of products associated with an e-commerce platform.

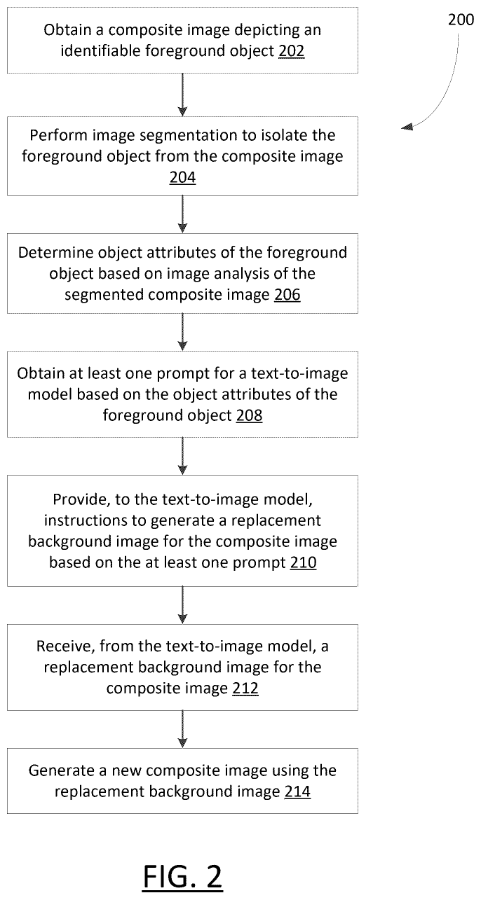

Reference is now made to FIG. 2 which shows, in flowchart form, an example method 200 for generating a new composite image based on a reference image. The method 200 may be implemented by a computing system that is configured to provide a user interface for interacting with a text-to-image model. For example, the operations of method 200 may be performed by at least one of the prompt generation engine 122 or user interface module 124 of FIG. 1.

In operation 202, the computing system obtains a reference composite image that depicts an identifiable foreground object. The reference image may be an image that is provided as input by a user of the computing system. For example, a user may upload, save, or otherwise provide, to the system, a specific reference image that includes one or more foreground objects. In some implementations, the reference image may be provided as part of a user request to generate a new composite image based on the reference image. For example, a user may request that a new composite image be constructed using a generative model, such as a text-to-image model, and the reference image may be provided as input for the image compositing task.

The computing system executes image segmentation on the reference image in order to isolate the foreground object from the background of the reference image, in operation 204. In particular, the computing system segments the reference image into foreground and background regions. The computing system implements an object detection model that is configured for processing input images to detect instances of semantic objects in the images. The object detection model may be trained to recognize items belonging to a defined class or segmentation label, e.g., products in a product catalogue. The computing system then partitions the reference image such that at least one image segment contains the detected foreground object. The image segmentation yields a segmented reference image which may be annotated for indicating at least the foreground object.

In at least some implementations, the computing system identifies a class of the foreground object using a trained classifier. The classifier may be trained to detect items of a particular semantic class in any given image. The computing system may select a segmentation mask for a defined class, and the segmentation mask may be used in determining regions corresponding to the foreground object within the reference image.

In operation 206, the computing system determines object attributes of the foreground object based on image analysis of the segmented reference image. The computing system may employ a multi-modal language model that is capable of analyzing images and outputting attribute labels. In some implementations, the computing system may provide the segmented reference image (or portions thereof) to a language model that is trained to output attribute labels of input images. The language model may, for example, be fine-tuned using a dataset of images depicting certain defined objects (e.g., products hosted on an e-commerce platform) and attribute labels associated with the objects. Additionally, or alternatively, the computing system may employ a multi-class machine learning classifier that is trained to extract attributes from images. The object attributes may comprise material, color, lighting parameters, size, pattern, style, and the like.

The computing system obtains at least one input prompt for a text-to-image model based on the object attributes of the foreground object (operation 208). The input prompt identifies a background that is desired to be replaced for the reference image. In at least some implementations, the computing system may provide, to a large language model (LLM), instructions to generate a text prompt based on the object attributes. The input to the LLM may comprise the object attributes (from operation 206) and an indication of the generative model (i.e., text-to-image model) for which the requested text prompt will be used.

Once the text prompt is output by the LLM, the computing system transmits, to the text-to-image model, instructions to generate a replacement background image for the reference image based on the text prompt (operation 210). In particular, the text prompt is provided as input to the text-to-image model. In operation 212, the computing system receives, from the text-to-image model, an output comprising a replacement background image for the reference image.

In operation 214, the computing system generates a new composite image using the replacement background image. More specifically, the new composite image is generated based on compositing portions of the reference image corresponding to the foreground object with the replacement background image. In at least some implementations, the computing system may extract the foreground object from the segmented reference image. That is, the computing system may implement background subtraction to extract the reference image's foreground for further processing. The new composite image may then be generated based on combining the extracted foreground object with the replacement background image.

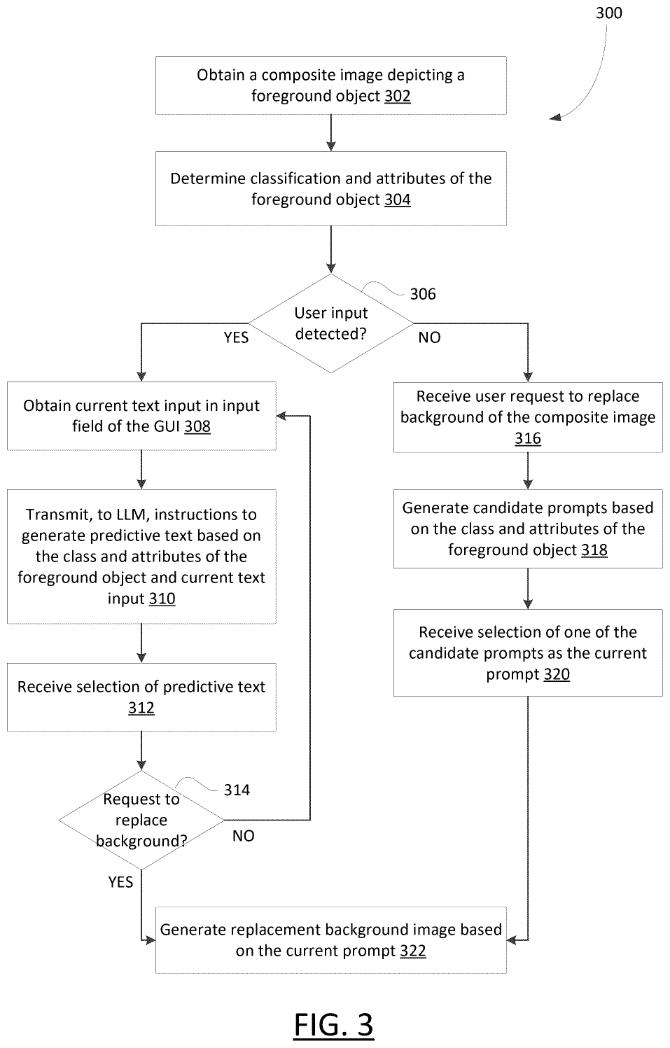

Reference is now made to FIG. 3 which shows, in flowchart form, an example method 300 for generating a replacement background image for a reference image. The method 300 may be implemented by a computing system that is configured to provide a user interface for interacting with a text-to-image model. For example, the operations of method 300 may be performed by at least one of the prompt generation engine 122 or user interface module 124 of FIG. 1. The operations of method 300 may be performed in addition to, or as alternatives of, one or more of the operations of method 200.

In operation 302, the computing system obtains a reference image depicting a foreground object. The reference image may be an image that is provided as input by a user of the computing system. For example, a user may upload, save, or otherwise provide, to the system, a specific reference image that includes one or more foreground objects. In some implementations, the reference image may be provided as part of a user request to generate a new composite image based on the reference image. For example, a user may request that a new composite image be constructed using a generative model, such as a text-to-image model, and the reference image may be provided as input for the image compositing task.

In operation 304, the computing system determines a class and attributes of the foreground object. As described above with reference to FIG. 2, the computing system may first perform segmentation of the reference image in order to identify the foreground object and background. Based on image analysis of the segmented reference image, the computing system determines the class and object attributes of the identified foreground object.

The computing system determines whether text input has been received via a user interface associated with the computing system, in operation 306. In particular, the computing system performs a check to determine if one or more designated input fields associated with the user interface contains text input. In at least some implementations, the user interface may be a graphical user interface associated with a software tool for interfacing with generative models. For example, the user interface may comprise an image generation and/or editing GUI that enables leveraging a text-to-image model. The designated input fields may include text input UI elements that are adapted for receiving user input of text prompts for the text-to-image model.

If no user input of text is detected, the computing system is configured to automatically construct candidate text prompts that may be used for generating a replacement background for the reference image. In operation 316, the computing system receives a user request to replace the background of the reference image. The computing system generates one or more candidate prompts based on the class and attributes of the foreground object (operation 318). In at least some implementations, the computing system may transmit, to an LLM, instructions for generating the one or more candidate prompts. In operation 320, the computing system receives user selection of one of the candidate prompts. The selection is received via the graphical user interface.

If, on the other hand, text input is received via the user interface, the computing system obtains current text input in the input field of the graphical user interface, in operation 308. That is, the computing system retrieves, in real-time, the text that is currently inputted into the input field UI element. For example, the computing system may retrieve all or a part of the current text data/value within the input field.

The computing system transmits, to an LLM, instructions to generate predictive text based on the current text input and one or both of the class and object attributes of the foreground object (operation 310). In some implementations, the predictive text data may comprise a next word suggestion. Additionally, or alternatively, the predictive text data may comprise a plurality of word suggestions. The predictive text items generated by the LLM are obtained by the computing system and provided to the user via the graphical user interface. In particular, the computing system may display the predictive text items as selectable options. For example, each of one or more of the predictive text items may be represented by a respective UI element (e.g., icon, menu item, and the like) and presented in the graphical user interface.

In operation 312, the computing system receives, via the graphical user interface, user selection of text from the predictive text data. In particular, the user selects one or more of the predictive text items using the graphical user interface. The selection represents the user's intention to modify the current text input with the selected predictive text item(s). Specifically, the current text input in the input field may be combined with the selected predictive text item(s) to obtain a revised, i.e., updated, text prompt.

In operation 322, the computing system generates a replacement background image based on the current text prompt. In some implementations, the user may provide a signal for expressly requesting to generate a replacement background for the reference image. For example, the user may select a UI element for initiating a request to obtain a replacement background for a user-provided reference image.

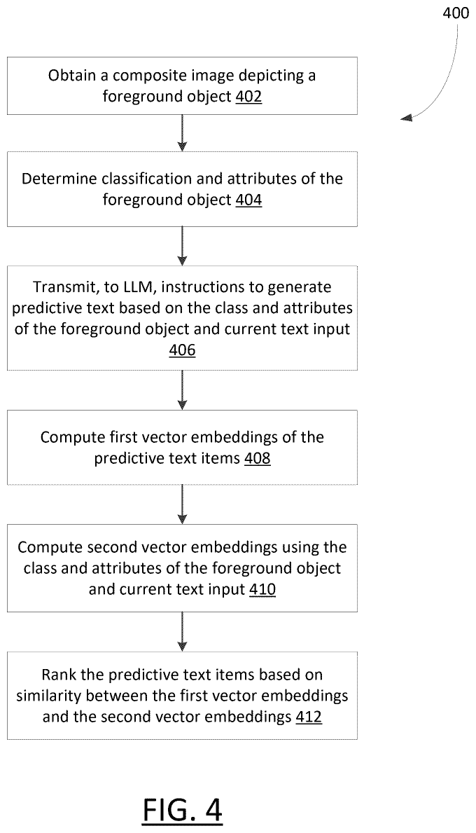

Reference is now made to FIG. 4 which shows, in flowchart form, an example method 400 of obtaining predictive text data for an input prompt to a generative AI model, namely a text-to-image model. The method 400 may be implemented by a computing system that is configured to provide a user interface for interacting with a text-to-image model. For example, the operations of method 400 may be performed by at least one of the prompt generation engine 122 or user interface module 124 of FIG. 1. The operations of method 400 may be performed in addition to, or as alternatives of, one or more of the operations of methods 200 and 300.

In operation 402, the computing system obtains a reference image depicting a foreground object. The reference image may be an image that is provided as input by a user of the computing system. For example, a user may upload, save, or otherwise provide, to the system, a specific reference image that includes one or more foreground objects. In some implementations, the reference image may be provided as part of a user request to generate a new composite image based on the reference image. For example, a user may request that a new composite image be constructed using a generative model, such as a text-to-image model, and the reference image may be provided as input for the image compositing task.

In operation 404, the computing system determines a class and attributes of the foreground object. As described above with reference to FIG. 2, the computing system may first perform segmentation of the reference image in order to identify the foreground object and background. Based on image analysis of the segmented reference image, the computing system determines the class and object attributes of the identified foreground object.

The computing system determines whether one or more designated input fields associated with the user interface contains text input. In at least some implementations, the user interface may be a graphical user interface associated with a software tool for interfacing with generative models. The designated input fields may include text input UI elements that are adapted for receiving user input of text prompts for a text-to-image model. The computing system obtains current text input in the input field of the graphical user interface. That is, the computing system retrieves, in real-time, the text that is currently inputted into the input field UI element. For example, the computing system may retrieve all or a part of the current text data/value within the input field. In operation 406, the computing system transmits, to an LLM, instructions to generate predictive text based on the current text input and the class and attributes of the foreground object. The LLM outputs predictive text items such as, for example, next word suggestions in connection with the current text input.

In operation 408, the computing system computes first vector embeddings of the predictive text items. More particularly, an embedding model is used to generate vector embeddings for each of one or more of the predictive text items output by the LLM. In operation 410, the computing system computes second vector embeddings using the current text input and the class and object attributes of the foreground object.

The computing system then determines a ranking of the outputs of the LLM, i.e., predictive text items, based on similarity between the first vector embeddings and the second vector embeddings (operation 412). That is, the predictive text items, which are candidate words for modifying the current text input, can be ranked by capturing latent features associated with the items and comparing to foreground object data and user-inputted text in order to determine similarity. For example, the computing system may use one or more metrics for calculating vector similarity such as, but not limited to, L2 (Euclidean) distance, cosine similarity, and inner product (dot product), when determining the ranking of predictive text items.

The ranking may be determined in real-time as a user inputs text for constructing an image generation prompt. In particular, the computing system may process the user input in real-time to derive a current list of predictive text items for the user input and to rank said items based on similarity. The dynamically updated ranking of the predictive text items can be used for determining an order to presenting the predictive text items as selectable options for augmenting user-inputted text. For example, the predictive text items may be presented, via the graphical user interface, as word suggestions in list-like format (e.g., drop-down menu), and the order of listing the predictive text items may be in accordance with the ranking determined in operation 412.

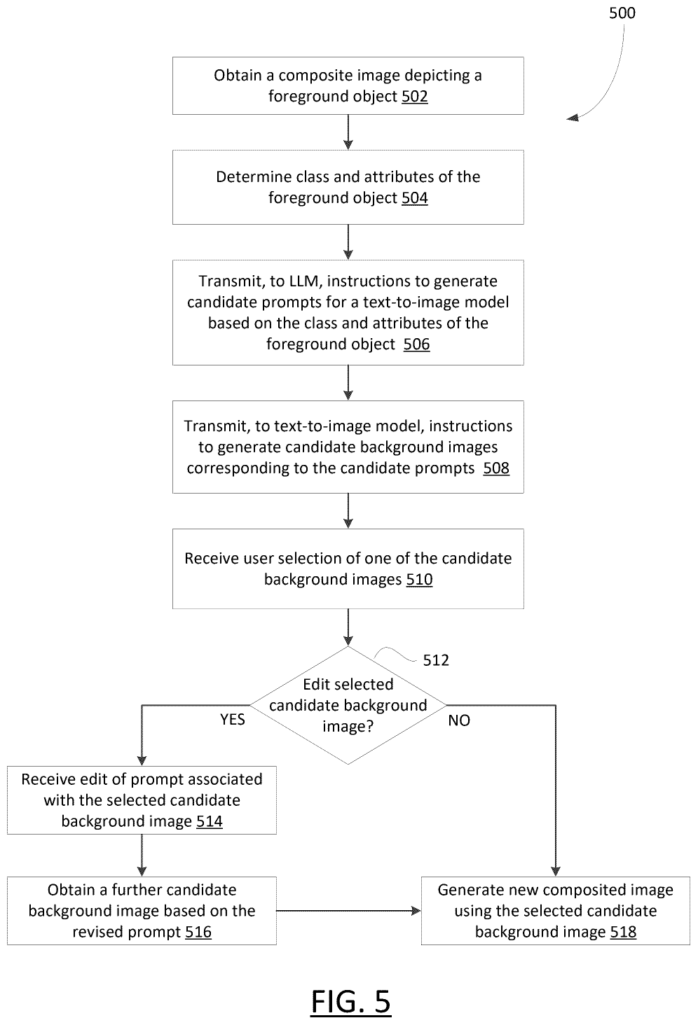

Reference is now made to FIG. 5 which shows, in flowchart form, another example method 500 for generating a new composite image based on a reference image. The method 500 may be implemented by a computing system that is configured to provide a user interface for interacting with a text-to-image model. For example, the operations of method 500 may be performed by at least one of the prompt generation engine 122 or user interface module 124 of FIG. 1. The operations of method 500 may be performed in addition to, or as alternatives of, one or more of the operations of methods 200, 300, and 400.

In operation 502, the computing system obtains a reference image depicting a foreground object. The reference image may be an image that is provided as input by a user of the computing system. For example, a user may upload, save, or otherwise provide, to the system, a specific reference image that includes one or more foreground objects. In some implementations, the reference image may be provided as part of a user request to generate a new composite image based on the reference image. For example, a user may request that a new composite image be constructed using a generative model, such as a text-to-image model, and the reference image may be provided as input for the image compositing task.

In operation 504, the computing system determines a class and attributes of the foreground object. The computing system may first perform segmentation of the reference image in order to identify the foreground object and background. Based on image analysis of the segmented reference image, the computing system determines the class and object attributes of the identified foreground object.

In operation 506, the computing system transmits, to an LLM, instructions to generate one or more candidate prompts for a text-to-image model based on the class and attributes of the foreground object.

The computing system receives, from the LLM, the generated candidate prompts. For each of the generated candidate prompts, the computing system provides, to a text-to-image model, instructions to generate a candidate background image corresponding to the candidate prompt (operation 508). The candidate background images are then presented, via a graphical user interface, as selectable options.

In operation 510, the computing system receives user selection of one of the candidate background images. The replacement background image comprises the selected candidate background image. In operation 512, the computing system determines whether a request is received to edit the selected candidate background image. If no such request is received, the computing system generates a new composited image using the selected candidate background image (operation 518). If, on the other hand, a request for editing the selected candidate background image is received, the computing system obtains, via the user interface, edits of the prompt associated with the selected candidate background image. In particular, the underlying text prompt used for generating the selected candidate background image is edited, and the edited prompt is received by the computing system. The computing system obtains a further candidate background image based on this revised text prompt. Specifically, the computing system provides, to the text-to-image model, instructions to generate a modified candidate background image based on the revised text prompt. In some implementations, the instructions may include the revised text prompt as well as the original selected candidate background image.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some implementations, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method, comprising:
obtaining a composite image depicting an identifiable foreground object;
performing image segmentation to isolate a foreground object from the composite image, the image segmentation yielding a segmented composite image;
determining object attributes of the foreground object based on image analysis of the segmented composite image;
obtaining at least one prompt for a text-to-image model based on the object attributes of the foreground object, the at least one prompt defining an intended replacement background for the composite image;
providing, to the text-to-image model, instructions to generate a replacement background image for the composite image based on the at least one prompt;
receiving, from the text-to-image model, a replacement background image for the composite image; and
generating a new composite image, the generating including compositing portions of the composite image corresponding to the foreground object with the replacement background image.

2. The method of claim 1, wherein obtaining the at least one prompt for the text-to-image model comprises:
determining current text input in an input field of a graphical user interface;
providing, to a large language model (LLM), instructions to generate predictive text data based on the object attributes of the foreground object and the current text input in the input field; and
presenting the predictive text data via the graphical user interface.

3. The method of claim 2, wherein the predictive text data comprises a next word suggestion.

4. The method of claim 2, further comprising:
receiving, via the graphical user interface, user selection of first text from the predictive text data; and
combining the current text input in the input field with the selected first text to obtain the at least one prompts.

5. The method of claim 2, wherein the predictive text data comprises a plurality of word suggestions and wherein each of the plurality of word suggestions is presented as a selectable option via the graphical user interface.

6. The method of claim 1, wherein determining the object attributes of the foreground object comprises providing at least a portion of the segmented composite image to a language model that is trained to output attribute labels of input images.

7. The method of claim 6, wherein the language model is fine-tuned using a dataset of images depicting first objects and attribute labels associated with the first objects.

8. The method of claim 2, further comprising:
computing input embeddings using the object attributes of the foreground object and the current text input; and
determining a ranking of outputs of the LLM based on a similarity measure between embeddings of predictive text candidates and the input embeddings.

9. The method of claim 1, further comprising extracting the foreground object from the segmented composite image, wherein the new composite image is generated based on combining the extracted foreground object with the replacement background image.

10. The method of claim 1, wherein obtaining the at least one prompt for the text-to-image model comprises providing, to an LLM, instructions to generate one or more candidate prompts based on the object attributes of the foreground object, and wherein providing instructions to the text-to-image model to generate the replacement background image comprises:
receiving, from the LLM, the generated candidate prompts; and
for each generated candidate prompt, providing, to the text-to-image model, instructions to generate a candidate background image corresponding to the candidate prompt.

11. The method of claim 10, further comprising presenting, via a graphical user interface, the candidate background images corresponding to the one or more candidate prompts as selectable options, wherein the replacement background image comprises a selection of one of the candidate background images.

12. The method of claim 10, further comprising:
receiving, via the graphical user interface, a selection of one of the candidate background images and user input of modifications to the candidate prompt associated with the selected candidate background image;
providing, to the text-to-image model, instructions to generate a modified candidate background image based on the modified candidate prompt.

13. The method of claim 1, wherein performing the image segmentation comprises identifying a class of the foreground object using a classifier.

14. A computing system, comprising:
a processor; and
a memory coupled to the processor, the memory storing computer-executable instructions that, when executed by the processor, configure the processor to:
obtain a composite image depicting an identifiable foreground object;
perform image segmentation to isolate a foreground object from the composite image, the image segmentation yielding a segmented composite image;
determine object attributes of the foreground object based on image analysis of the segmented composite image;
obtain at least one prompt for a text-to-image model based on the object attributes of the foreground object, the at least one prompt defining an intended replacement background for the composite image;
provide, to the text-to-image model, instructions to generate a replacement background image for the composite image based on the at least one prompt;
receive, from the text-to-image model, a replacement background image for the composite image; and
generate a new composite image, the generating including compositing portions of the composite image corresponding to the foreground object with the replacement background image.

15. The computing system of claim 14, wherein the instructions, when executed, further configure the processor to:
determine current text input in an input field of a graphical user interface;
provide, to a large language model (LLM), instructions to generate predictive text data based on the object attributes of the foreground object and the current text input in the input field; and
present the predictive text data via the graphical user interface.

16. The computing system of claim 15, wherein the instructions, when executed, further configure the processor to:
receive, via the graphical user interface, user selection of first text from the predictive text data; and
combine the current text input in the input field with the selected first text to obtain the at least one prompts.

17. The computing system of claim 15, wherein the instructions, when executed, further configure the processor to:
compute input embeddings using the object attributes of the foreground object and the current text input; and
determine a ranking of outputs of the LLM based on a similarity measure between embeddings of predictive text candidates and the input embeddings.

18. The computing system of claim 14, wherein obtaining the at least one prompt for the text-to-image model comprises providing, to an LLM, instructions to generate one or more candidate prompts based on the object attributes of the foreground object, and wherein providing instructions to the text-to-image model to generate the replacement background image comprises:
receiving, from the LLM, the generated candidate prompts; and
for each generated candidate prompt, providing, to the text-to-image model, instructions to generate a candidate background image corresponding to the candidate prompt.

19. The computing system of claim 18, wherein the instructions, when executed, further configure the processor to:
receive, via the graphical user interface, a selection of one of the candidate background images and user input of modifications to the candidate prompt associated with the selected candidate background image;
provide, to the text-to-image model, instructions to generate a modified candidate background image based on the modified candidate prompt.

20. A non-transitory, computer-readable medium storing instructions that, when executed by a processor, configure the processor to:
obtain a composite image depicting an identifiable foreground object;
perform image segmentation to isolate a foreground object from the composite image, the image segmentation yielding a segmented composite image;
determine object attributes of the foreground object based on image analysis of the segmented composite image;
obtain at least one prompt for a text-to-image model based on the object attributes of the foreground object, the at least one prompt defining an intended replacement background for the composite image;
provide, to the text-to-image model, instructions to generate a replacement background image for the composite image based on the at least one prompt;
receive, from the text-to-image model, a replacement background image for the composite image; and
generate a new composite image, the generating including compositing portions of the composite image corresponding to the foreground object with the replacement background image.
